(19) United States
(12) Patent Application Publication
(10) Pub. No.: US 2017/0317383 A1
(43) Pub. Date: Nov. 2, 2017

(54) LITHIUM-ION SECONDARY BATTERY

(71) Applicant: HITACHI MAXELL, LTD., Ibaraki-shi, Osaka (JP)

(72) Inventors: Keisuke KAWABE, Osaka (JP); Hiroshi ABE, Osaka (JP); Daisuke GOTO, Osaka (JP); Takako SHIBA, Osaka (JP); Ryongtae HAN, Osaka (JP)

(73) Assignee: HITACHI MAXELL, LTD., Ibaraki-shi, Osaka (JP)

(21) Appl. No.: 15/523,249

(22) PCT Filed: Oct. 23, 2015
(86) PCT No.: PCT/JP2015/079930

§ 371 Date: Apr. 28, 2017

(30) Foreign Application Priority Data
Oct. 29, 2014 (JP) 2014-219943

(51) Int. Cl. H01M 10/0567; H01M 10/0569; H01M 4/525; H01M 4/36; H01M 4/587; H01M 10/0525; H01M 10/0568

(52) U.S. Cl. CPC H01M 10/0567; H01M 10/0525; H01M 10/0569; H01M 10/0568; H01M 4/364; H01M 4/587; H01M 4/525; H01M 2300/004

(57) ABSTRACT

A lithium-ion secondary battery of the present invention includes a positive electrode, a negative electrode, a non-aqueous electrolytic solution, and a separator. The positive electrode includes, as a positive electrode active material, a lithium-containing oxide that contains at least one element selected from Co and Mn. The negative electrode includes, as a negative electrode active material, graphite having a d₀₀₂ in X-ray diffraction of 0.338 nm or less and a carbonaceous material having a d₀₀₂ in X-ray diffraction of 0.340 to 0.380 nm. The negative electrode active material contains the carbonaceous material in an amount of 5 to 15 mass %. The non-aqueous electrolytic solution contains LiBF₄, a nitrile compound having one or more cyano groups, and LiPF₆. The non-aqueous electrolytic solution contains the LiBF₄ in an amount of 0.05 to 2.5 mass % and the nitrile compound in an amount of 0.05 to 5.0 mass %.

### TECHNICAL FIELD

The present invention relates to a lithium-ion secondary battery that has excellent charge-discharge cycle characteristics and storage characteristics even at high temperatures and thus has excellent overcharge characteristics.

### BACKGROUND ART

Lithium-ion secondary batteries, which are a type of electrochemical element, are characterized by having high energy density, and therefore, the applications thereof to portable devices, automobiles, electric-powered tools, electric-powered chairs, and power storage systems for household use and for business use are being looked into. In particular, lithium-ion secondary batteries are widely used as a power source for portable devices such as cellular phones, smartphones, and tablet PCs.

An increase in the capacity of the lithium-ion secondary batteries and improvements in various battery characteristics thereof have been in demand as a result of an increase in the number of devices in which the lithium-ion secondary batteries are used, or the like. In particular, an improvement in charge-discharge cycle characteristics has been in great demand for secondary batteries.

Carbon materials into and from which Li ions can be inserted and desorbed are usually used as a negative electrode active material for lithium-ion secondary batteries. In particular, natural or synthetic graphite has high capacity and excellent charge-discharge cycle characteristics, and thus is used widely.

Proposed is a method of adding Si, Sn, or an additive made of a material containing these elements to a negative electrode active material for the purpose of further improving the charge-discharge cycle characteristics in the case where natural or synthetic graphite is used as the negative electrode active material (Patent Document 1).

Meanwhile, Patent Document 2 discloses a non-aqueous secondary battery having high capacity and excellent charge-discharge cycle characteristics and storage characteristics that includes, as a positive electrode active material, a lithium-containing transition metal oxide containing a specific metal element and in which a non-aqueous electrolyte contains a compound having two or more nitrile groups in a molecule.

Patent Document 3 discloses a non-aqueous electrolyte secondary battery having excellent discharge rate characteristics and high-temperature storage characteristics due to the use of a non-aqueous electrolytic solution containing a specific additive for an electrolytic solution.

However, Patent Documents 1 to 3 do not refer to high-temperature cycle characteristics. Patent Document 2 refers to an effect of a nitrile-based compound on a positive electrode, but does not refer to a relationship between a negative electrode and the nitrile-based compound. Furthermore, since the upper limit of the charging voltage can be increased, there is still room for improvement in the characteristics of a non-aqueous secondary battery.

### CITATION LIST

### Patent Documents

Patent Document 1: JP 2012-084426A

Patent Document 2: JP 2008-108586A

Patent Document 3: JP 2007-053083A

### DISCLOSURE OF INVENTION

### Problem to be Solved by the Invention

An example of a problem of the lithium-ion secondary battery using the above-mentioned graphite as the negative electrode active material is a problem in that repeated charging and discharging or an overcharge state of the battery in an abnormal condition results in the deposition of Li metal dendrite on the surface of the negative electrode. This Li dendrite may break through a separator and cause a short circuit or may react with a non-aqueous electrolyte and cause the generation of a gas. Therefore, there is a need to develop a technique for suppressing the generation of such a dendrite to improve the charge-discharge cycle characteristics of a battery.

In general, a lithium-containing composite oxide such as LiCoO₂ or LiMn₂O₄ is used as the positive electrode active material in the lithium-ion secondary battery. When the fully charged battery is exposed to high temperatures, a problem arises in that a metal such as Co or Mn is eluted from the positive electrode active material and deposited on the surface of the negative electrode, resulting in the deterioration of the battery characteristics. Therefore, there is a need to develop a technique for avoiding this situation.

The present invention was achieved in light of the aforementioned circumstances, and provides a lithium-ion secondary battery having excellent charge-discharge cycle characteristics and high-temperature storage characteristics as well as being highly safe while overcharged.

### Means for Solving Problem

An aspect of the present invention is a lithium-ion secondary battery including a positive electrode, a negative electrode, a non-aqueous electrolytic solution, and a separator, wherein the positive electrode includes, as a positive electrode active material, a lithium-containing oxide that contains at least one element selected from Co and Mn, the negative electrode includes, as a negative electrode active material, graphite having a d₀₀₂ in X-ray diffraction of 0.338 nm or less and a carbonaceous material having a d₀₀₂ in X-ray diffraction of 0.340 to 0.380 nm, the negative electrode active material contains the carbonaceous material in an amount of 5 to 15 mass %, the non-aqueous electrolytic solution contains LiBF₄, a nitrile compound having one or more cyano groups, and LiPF₆, and the non-aqueous electrolytic solution contains the LiBF4 in an amount of 0.05 to 2.5 mass % and the nitrile compound in an amount of 0.05 to 5.0 mass %.

### Effects of the Invention

With the present invention, a lithium-ion secondary battery that exhibits excellent charge-discharge cycle characteristics at high temperatures and has excellent high-temperature storage characteristics and overcharge characteristics can be provided.

### BRIEF DESCRIPTION OF DRAWINGS

FIG. 1 is a longitudinal partial cross-sectional view, schematically showing an example of a lithium-ion secondary battery of the present invention.

FIG. 2 is a perspective view of FIG. 1.

### DESCRIPTION OF THE INVENTION

A lithium-ion secondary battery of the present invention includes a positive electrode, a negative electrode, a non-aqueous electrolytic solution, and a separator. The above positive electrode includes, as a positive electrode active material, a lithium-containing oxide that contains at least one element selected from Co and Mn. The above negative electrode includes, as a negative electrode active material, graphite having a d₀₀₂ in X-ray diffraction of 0.338 nm or less and a carbonaceous material having a d₀₀₂ in X-ray diffraction of 0.340 to 0.380 nm, and the negative electrode active material contains the carbonaceous material in an amount of 5 to 15 mass %. The above non-aqueous electrolytic solution contains LiBF₄, a nitrile compound having one or more cyano groups, and LiPF₆, and the non-aqueous electrolytic solution contains the LiBF₄ in an amount of 0.05 to 2.5 mass % and the nitrile compound in an amount of 0.05 to 5.0 mass %.

Negative Electrode

A negative electrode having a structure in which a negative electrode mixture layer containing a negative electrode active material, a binder, and the like is formed on one or both surfaces of a current collector is used as the negative electrode according to the lithium-ion secondary battery of the present invention.

The negative electrode active material of the present invention contains graphite having a d₀₀₂ in X-ray diffraction of 0.338 nm or less and a carbonaceous material having a d₀₀₂ in X-ray diffraction of 0.340 to 0.380 nm, and the non-aqueous electrolytic solution contains lithium borofluoride (LiBF₄) and a nitrile compound having one or more cyano groups. During charging, Li ions are first occluded by the carbonaceous material and then gradually occluded by the graphite material. Thereafter, in the case where Li ions are generated in an excessive amount to the extent that the graphite material cannot take on all of the Li ions, the carbonaceous material takes on the Li ions again, and thus the deposition of Li dendrite on the surface of the negative electrode can be suppressed. Therefore, the charge-discharge cycle characteristics and overcharge characteristics of the battery can be improved.

Investigation conducted by the inventors of the present invention revealed that a coating of LiBF4 formed on the negative electrode was different from that formed in the case where only graphite having a d₀₀₂ of 0.338nm or less was used as the negative electrode active material, and thus the storage characteristics, high-temperature cycle characteristics, and overcharge characteristics were improved compared with the case where graphite having a d₀₀₂ of 0.338nm or less was used. The reason for this is unclear, but is presumed as follows. It is thought that Li dendrite is likely to be deposited due to excessive Li ions concentrating where the coating on the surface of the negative electrode is non-uniform and the resistance decreasing locally, but the coating of LiBF4 on the negative electrode is a uniform coating having a lower interface resistance than that of a conventional one, thus making it possible to further suppress the generation of Li dendrite. Furthermore, using LiBF4 together with a nitrile compound having one or more cyano groups makes it possible to improve the thermal stability of the coating on the negative electrode.

Regarding the positive electrode, although details will be specifically described later, LiBF₄ and the nitrile compound having one or more cyano groups in the non-aqueous electrolytic solution form a coating on the positive electrode, and thus the elution of a metal such as Co or Mn from the positive electrode active material is suppressed, but Co or Mn, which is eluted due to its elution not being suppressed sufficiently, selectively moves to the above-mentioned carbonaceous material, and as a result, the eluted metal is trapped by the carbonaceous material, thus making it possible to suppress deterioration of the negative electrode and improve the high-temperature storage characteristics of the battery.

In the present invention, graphite that can occlude and release Li ions is used as the negative electrode active material. Examples of such graphite include natural graphite such as flake graphite; natural graphite with an amorphous carbon coating layer formed on its surface; and synthetic graphite obtained by performing graphitization on easily-graphitizable carbon such as pyrolytic carbon, coke, MCMB, or carbon fibers at 2800° C. or higher.

In the present invention, graphite having a d₀₀₂, which is a surface spacing of a (002) surface, of 0.338 nm or less is used. The reason for this is that using such an active material makes it possible to increase the capacity of the battery. It should be noted that the lower limit value of the d₀₀₂ is not particularly limited, but is 0.335 nm theoretically.

It is sufficient that the particle diameter, specific surface area, and R value of the graphite having a d₀₀₂ of 0.338 nm or less are selected as appropriate without departing from the object of the present invention. Specifically, graphite having a d₀₀₂ of 0.338 nm or less that has an average particle diameter D50% of 10 μm or more and 30 μm or less can be used, graphite having a d₀₀₂ of 0.338 nm or less that has a specific surface area (determined using a BET method) of 1 m²/g or more and 5 m²/g or less can be used, and graphite having a d₀₀₂ of 0.338 nm or less that has an R value of 0.1 or more and 0.7 or less can be used.

The “average particle diameter D50%” refers to an average particle diameter D50% determined through measurement performed using a laser scattering particle size distribution analyzer (e.g., “LA-920” manufactured by HORIBA, Ltd.) on fine particles that have been dispersed in a medium in which the particles are not dissolved. The specific surface area is determined using a BET method, and an example of a measurement apparatus is “BELSORP-mini” manufactured by BEL Japan, Inc. The “R value” refers to an R value (1₁₃₆₀/I₁₅₈₀) that is a ratio of the peak intensity at 1360 cm⁻¹ with respect to the peak intensity at 1580 cm⁻¹ in an argon-ion laser Raman spectrum, and can be determined from a Raman spectrum obtained by using an argon laser (e.g., “T-5400” (laser power: 1 mW) manufactured by Ramanaor) in which the wavelength is 514.5 nm.

Lc, which is the size of a crystallite in a c axis direction, in the crystal structure of the graphite is preferably 3 nm or more, more preferably 8 nm or more, and even more preferably 25 nm or more. The reason for this is that setting the Lc within this range further facilitates the occlusion and desorption of lithium ions. The upper limit value of the Lc of the graphite is not particularly limited, but is generally about 200 nm.

In the present invention, the negative electrode active material contains the graphite having a d₀₀₂ of 0.338 nm or less in an amount of preferably 85 mass % or more and 95 mass % or less. When the negative electrode contains the graphite in an amount within this range, high charge-discharge cycle characteristics of the lithium-ion secondary battery can be secured.

Examples of the carbonaceous material having a d₀₀₂ of 0.340 to 0.380 nm include easily-graphitizable carbon such as pyrolytic carbon, coke, MCMB, or carbon fibers that have not undergone graphitization, and hardly-graphitizable carbon such as a carbonized phenol resin.

Relative to Li, this type of carbonaceous material occludes Li ions at a nobler potential than that of graphite having a d₀₀₂ of 0.338 nm or less, and therefore, as described above, in the case where Li ions are generated in an excessive amount to the extent that the graphite material cannot take on all of the Li ions, the carbonaceous material takes on the Li ions, thus making it possible to suppress the deposition of Li dendrite on the surface of the negative electrode, resulting in an improvement in safety.

It is sufficient that the particle diameter, specific surface area, and R value of the carbonaceous material having a d₀₀₂ of 0.340 to 0.380 nm are selected as appropriate without departing from the object of the present invention. Specifically, a carbonaceous material having a d₀₀₂ of 0.340 to 0.380 nm that has an average particle diameter D50% of 5 μm or more and 25 μm or less can be used, a carbonaceous material having a 402 of 0.340 to 0.380 nm that has a specific surface area of 1 m²/g or more and 15 m²/g or less can be used, and a carbonaceous material having a d₀₀₂ of 0.340 to 0.380 nm that has an R value of 0.3 or more and 0.8 or less can be used. It should be noted that the average particle diameter D50%, the specific surface area, and the R value can be measured using the same methods as those described above.

In the present invention, the negative electrode active material contains the carbonaceous material having a d₀₀₂ of 0.340 to 0.380 nm in an amount of 5 to 15 mass %. Setting the content of the carbonaceous material within this range makes it possible to favorably secure the above-mentioned effects obtained by using the carbonaceous material. The negative electrode active material may contain a negative electrode active material other than the graphite having a d₀₀₂ of 0.338 nm or less and the carbonaceous material having a d₀₀₂ of 0.340 to 0.380 nm to the extent that the effects of the invention are not inhibited.

The above-mentioned carbonaceous material may be uniformly dispersed in the negative electrode mixture layer or unevenly distributed in a specific region of the negative electrode mixture layer, for example.

A material that is electrochemically inert to Li and has as little effect on other substances as possible within the electric potential range in which the negative electrode is used, for example, is selected as the binder according to the negative electrode mixture layer. Specifically, preferred examples thereof include styrene-butadiene rubber (SBR), polyvinylidene fluoride (PVDF), carboxymethylcellulose (CMC), methylcellulose, polyimide, and polyamideimide. These binders may be used alone or in combination of two or more.

Various types of carbon black such as acetylene black, carbon nanotubes, or carbon fibers may be added to the negative electrode mixture layer as a conductive assistant.

The negative electrode is manufactured through steps of preparing a composition containing a negative electrode mixture by dispersing the negative electrode active material, the binder, and optionally the conductive assistant in a solvent such as N-methyl-2-pyrrolidone (NMP) or water (it should be noted that the binder may be dissolved in the solvent), applying this composition to one or both surfaces of a current collector, and optionally performing calendering processing after drying the composition. However, the method of manufacturing the negative electrode is not limited to the above method, and the negative electrode may be manufactured using another manufacturing method.

It is preferable that the thickness of the negative electrode mixture layer on each surface of the current collector is 10 to 100 μm, and the density of the negative electrode mixture layer (calculated from the mass and the thickness per unit area of the negative electrode mixture layer formed on the current collector) is 1.0 to 1.9 g/cm³. It is preferable that the composition of the negative electrode mixture layer includes the negative electrode active material in an amount of 80 to 95 mass % and the binder in an amount of 1 to 20 mass %. When the conductive assistant is used, the content thereof is preferably 1 to 10 mass %.

A foil, a punched metal, a net, an expanded metal, or the like, which are made of copper or nickel, can be used as the current collector of the negative electrode, and a copper foil is generally used. In the case where the entire thickness of this negative electrode current collector is reduced for the purpose of obtaining a battery having high energy density, it is preferable that the upper limit of the thickness is 30 μm, and it is desirable that the lower limit of the thickness is 5 μm in order to secure mechanical strength.

Non-Aqueous Electrolytic Solution

The non-aqueous electrolytic solution of the present invention contains lithium borofluoride (LiBF4) and a nitrile compound having one or more cyano groups.

A possible reason for the elution of Co or Mn from the positive electrode active material at high temperature is that LiPF₆ in the non-aqueous electrolytic solution is decomposed to produce hydrogen fluoride (HF), and HF breaks the crystal structure of the positive electrode active material, resulting in the elution of Co or Mn. LiBF₄ and the nitrile compound are compounds that form a highly stable coating on the positive electrode even at high temperature. By causing the non-aqueous electrolytic solution to contain these compounds, the reaction between HF and the positive electrode active material can be suppressed, and thus the elution of Co or Mn itself can be suppressed. This makes it possible to improve the high-temperature cycle characteristics and high-temperature storage characteristics.

Applying this configuration to the non-aqueous electrolytic solution with the above-described configuration of the negative electrode being applied causes an interaction therebetween, thus making it possible to impart excellent charge-discharge cycle characteristics and high-temperature storage characteristics as well as making the lithium-ion secondary battery highly safe during overcharge.

LiBF₄ is more stable than LiPF₆ at high temperatures, and therefore, the amount of HF generated through the decomposition of LiBF₄ itself does not increase. Since LiBF4 has a low molecular weight, the addition amount that enables LiBF₄ to exhibit the effects is smaller than the addition amount that enables other additives to exhibit the same effects. Moreover, since LiBF₄ forms an inorganic dense negative electrode coating, the coating itself has low resistance, thus making it possible to suppress deterioration of load characteristics. Furthermore, LiBF₄ does not contribute to the generation of a gas during storage at high temperatures.

In particular, it is desirable that a compound represented by General Formula (1) below is used as the above-mentioned nitrile compound having one or more cyano groups.

NC—(CH₂)ₙ—CN (1)

It should be noted that, in General Formula (1) above, n is an integer between 2 to 4.

Examples of the compound represented by General Formula (1) above include malononitrile, succinonitrile, glutaronitrile, adiponitrile, 1,4-dicyanoheptane, 1,5-dicyanopentane, 1,6-dicyanohexane, 1,7-dicyanoheptane, 2,6-dicyanoheptane, 1,8-dicyanooctane, 2,7-dicyanooctane, 1,9-dicyanononane, 2,8-dicyanononane, 1,10-dicyanodecane, 1,6-dicyanodecane, and 2,4-dimethylglutaronitrile.

These compounds can form a highly stable coating on the positive electrode even at high temperatures and high voltages. This makes it possible to suppress the breakage of the crystal structure of the positive electrode active material by HF, thus making it possible to suppress the elution of Co or Mn. Of these compounds, adiponitrile and succinonitrile are highly stable at high temperatures and can be widely used, and thus are preferable.

In order to obtain the above-described effects, the non-aqueous electrolytic solution contains LiBF4 in an amount of 0.05 mass % or more, and preferably 0.1 mass % or more. The above content is 2.5 mass % or less, and preferably 0.5 mass % or less.

The non-aqueous electrolytic solution contains the nitrile compound having one or more cyano groups in an amount of 0.05 mass % or more, and preferably 0.1 mass % or more. The above content is 5.0 mass % or less, and preferably 2 mass % or less.

Lithium salts according to the non-aqueous electrolytic solution of the present invention include LiPF₆. LiPF₆ is the most versatile lithium salt that has a high degree of dissociation and a high Li-ion transport ratio. The non-aqueous electrolytic solution may also contain other lithium salts such as LiClO₄, LiSbF₆, LiCF₃SO₃, LiCF₃CO2, Li₂C₂F₄(SO₃)₂, LiC(CF₃SO₂)₃, and LiCₙF₂ₙ₊₁SO₃(2≦n≦7) in addition to LiPF₆ to the extent that the effects of the present invention are not inhibited. The concentration of lithium salt in the non-aqueous electrolytic solution is preferably set to 0.6 to 1.8 mol/L, and more preferably 0.9 to 1.6 mol/L.

For example, a solution (non-aqueous electrolytic solution) prepared by dissolving the above-mentioned lithium salts including LiPF₆, LiBF₄, and a nitrile compound in a non-aqueous solvent below can be used as the non-aqueous electrolytic solution of the present invention.

As the non-aqueous solvent, aprotic organic solvents such as ethylene carbonate (EC), propylene carbonate (PC), butylene carbonate (BC), dimethyl carbonate (DMC), diethyl carbonate (DEC), methylethyl carbonate (MEC), γ-butyrolactone (γ-BL), 1,2-dimethoxyethane (DME), tetrahydrofuran (THF), 2-methyltetrahydrofuran, dimethyl sulfoxide (DMSO), 1,3-dioxolane, formamide, dimethylformamide (DMF), dioxolane, acetonitrile, nitromethane, methyl formate, methyl acetate, phosphoric acid triester, trimethoxymethane, dioxolane derivatives, sulfolane, 3-methyl-2-oxazolidinone, propylene carbonate derivatives, tetrahydrofuran derivatives, and diethylether can be used alone, or a mixed solvent obtained by mixing two or more of the aprotic organic solvents can be used.

Additives (including their derivatives) such as 1,3-propanesultone, 1,3-dioxane, vinylene carbonate, vinylethylene carbonate, fluorinated carbonates such as 4-fluoro-1,3-dioxolan-2-one, acid anhydrides, sulfonates, diphenyl disulfide, cyclohexylbenzene, biphenyl, fluorobenzene, and t-butylbenzene can also be added to the non-aqueous electrolytic solution used in the lithium-ion secondary battery of the present invention as appropriate for the purpose of further improving the charge-discharge cycle characteristics and improving properties related to safety such as high-temperature storage properties or overcharge prevention.

It is preferable that the non-aqueous electrolytic solution contains 1,3-dioxane out of these additives. This makes it possible to further improve the charge-discharge cycle characteristics of the lithium-ion secondary battery at high temperatures.

The non-aqueous electrolytic solution used in the lithium-ion secondary battery contains 1,3-dioxane in an amount of preferably 0.1 mass % or more, and more preferably 0.5 mass % or more from the viewpoint that the effects of using 1,3-dioxane is more favorably secured. However, if the non-aqueous electrolytic solution contains 1,3-dioxane in an excessive amount, there is a risk that the load characteristics of the battery deteriorates, or the effect of improving the charge-discharge cycle characteristics is reduced. Therefore, the non-aqueous electrolytic solution used in the lithium-ion secondary battery contains 1,3-dioxane in an amount of preferably 5 mass % or less and more preferably 2 mass % or less.

Causing the non-aqueous electrolytic solution to contain vinylene carbonate and 4-fluoro-1,3-dioxolan-2-one makes it possible to further improve the charge-discharge cycle characteristics. It is preferable that the contents of vinylene carbonate and 4-fluoro-1,3-dioxolan-2-one in the non-aqueous electrolytic solution is 0.1 to 5.0 mass % and 0.05 to 5.0 mass %, respectively.

It is preferable that the non-aqueous electrolytic solution contains a phosphonoacetate compound represented by General Formula (2) below. A phosphonoacetate compound contributes, together with LiBF₄, to the formation of a coating on the surface of the negative electrode of the lithium-ion secondary battery, resulting in the formation of a firmer coating. Therefore, the deterioration of the negative electrode active material and the deterioration of the non-aqueous electrolytic solution can be further suppressed.

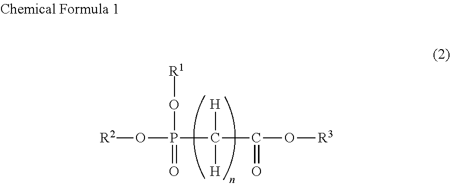

In General Formula (2) above, R¹, R², and R³ independently represent an alkyl group, an alkenyl group, or an alkynyl group that has 1 to 12 carbon atoms and is optionally substituted with a halogen, and n represents an integer between 0 to 6.

Specific examples of the phosphonoacetate compound represented by General Formula (2) above include the following compounds.

Compounds represented by General Formula (2) above in which n is 0

Trimethyl phosphonoformate, methyl diethyl phosphonoformate, methyl dipropyl phosphonoformate, methyl dibutyl phosphonoformate, triethyl phosphonoformate, ethyl dimethyl phosphonoformate, ethyl diethyl phosphonoacetate, ethyl dipropyl phosphonoformate, ethyl dibutyl phosphonoformate, tripropyl phosphonoformate, propyl dimethyl phosphonoformate, propyl diethyl phosphonoformate, propyl dibutyl phosphonoformate, tributyl phosphonoformate, butyl dimethyl phosphonoformate, butyl diethyl phosphonoformate, butyl dipropyl phosphonoformate, methyl bis(2,2,2-trifluoroethyl) phosphonoformate, ethyl bis(2,2,2-trifluoroethyl) phosphonoformate, propyl bis(2,2,2-trifluoroethyl) phosphonoformate, butyl bis(2,2,2-trifluoroethyl) phosphonoformate, and the like.

Compounds represented by General Formula (2) above in which n is 1

Trimethyl phosphonoacetate, methyl diethyl phosphonoacetate, methyl dipropyl phosphonoacetate, methyl dibutyl phosphonoacetate, triethyl phosphonoacetate, ethyl dimethyl phosphonoacetate, ethyl dipropyl phosphonoacetate, ethyl dibutyl phosphonoacetate, tripropyl phosphonoacetate, propyl dimethyl phosphonoacetate, propyl diethyl phosphonoacetate, propyl dibutyl phosphonoacetate, tributyl phosphonoacetate, butyl dimethyl phosphonoacetate, butyl diethyl phosphonoacetate, butyl dipropyl phosphonoacetate, methyl bis(2,2,2-trifluoroethyl) phosphonoacetate, ethyl bis(2,2,2-trifluoroethyl) phosphonoacetate, propyl bis(2,2,2-trifluoroethyl) phosphonoacetate, butyl bis(2,2,2-trifluoroethyl) phosphonoacetate, allyl dimethyl phosphonoacetate, allyl diethyl phosphonoacetate, 2-propynyl dimethyl phosphonoacetate, 2-propynyl diethyl phosphonoacetate, 2-propynyl 2-(diethoxyphosphoryl) acetate, and the like.

Compounds represented by General Formula (2) above in which n is 2

Trimethyl 3-phosphonopropionate, methyl 3-(diethylphosphono)propionate, methyl 3-(dipropylphosphono)propionate, methyl 3-(dibutylphosphono)propionate, triethyl 3-phosphonopropionate,ethyl 3-(dimethylphosphono)propionate, ethyl 3-(dipropylphosphono)propionate, ethyl 3-(dibutylphosphono)propionate, tripropyl 3-phosphonopropionate, propyl 3-(dimethylphosphono)propionate, propyl 3-(diethylphosphono)propionate, propyl 3-(dibutylphosphono)propionate, tributyl 3-phosphonopropionate, butyl 3-(dimethylphosphono)propionate, butyl 3-(diethylphosphono)propionate, butyl 3-(dipropylphosphono)propionate, methyl 3-(bis(2,2,2-trifluoroethyl)phosphono)propionate, ethyl 3-(bis(2,2,2-trifluoroethyl)phosphono)propionate, propyl 3-(bis(2,2,2-trifluoroethyl)phosphono)propionate, butyl 3-(bis(2,2,2-trifluoroethyllphosphono)propionate, and the like.

Compounds represented by General Formula (2) above in which n is 3

Trimethyl 4-phosphonobutylate, methyl 4-(diethylphosphono)butylate, methyl 4-(dipropylphosphono)butylate, methyl 4-(dibutylphosphono)butylate, triethyl 4-phosphonobutylate, ethyl 4-(dimethylphosphono)butylate, ethyl 4-(dipropylphosphono)butylate, ethyl 4-(dibutylphosphono)butylate, tripropyl 4-phosphonobutylate, propyl 4-(dimethylphosphono)butylate, propyl 4-(diethylphosphono)butylate, propyl 4-(dibutylphosphono)butylate, tributyl 4-phosphonobutylate, butyl 4-(dimethylphosphono)butylate, butyl 4-(diethylphosphono)butylate, butyl 4-(dipropylphosphono)butylate, and the like.

It is preferable to use 2-propynyl diethyl phosphonoacetate (PDEA) and ethyl diethyl phosphonoacetate (EDPA) out of the phosphonoacetate compounds.

Positive Electrode

The positive electrode according to the lithium-ion secondary battery of the present invention includes at least a positive electrode active material, and an example thereof is an electrode obtained by forming a positive electrode mixture layer containing the positive electrode active material on one or both surfaces of a current collector. The positive electrode mixture layer contains a binder and optionally a conductive assistant in addition to the positive electrode active material. For example, the positive electrode mixture layer can be formed to have a desired thickness by applying a composition (e.g., slurry) containing a positive electrode mixture to the surface of the current collector and drying the composition, the composition being obtained by adding an appropriate solvent to a mixture (positive electrode mixture) containing the positive electrode active material, the binder (in addition, the conductive assistant), and the like and kneading the resulting mixture sufficiently. Moreover, the thickness and density of the positive electrode mixture layer can also be adjusted by performing press processing as needed on the positive electrode on which the positive electrode mixture layer has been formed.

The present invention is based on the premise that the positive electrode active material includes a lithium-containing oxide containing at least one element selected from Co and Mn (referred to as “lithium-containing oxide containing Co and/or Mn” hereinafter), and a conventionally known positive electrode active material for a lithium-ion secondary battery that contains these elements can be used. Specific examples of such a positive electrode active material include: lithium-containing transition metal oxides having a layer structure represented by Li₁₊ₓMO₂(−0.1<x<0.1; M: Co, Ni, Mn, Al, Mg, or the like); lithium manganese oxides having a spinel structure such as LiMn₂O₄ and substitution products thereof obtained by substituting a portion of the elements in LiMn₂O₄ with other elements; and olivine compounds represented by LiMPO₄ (M: Co, Ni, Mn, Fe, or the like). Specific examples of the above-mentioned lithium-containing transition metal oxides having a layer structure include oxides containing at least Co, Ni, and Mn LiMn_{1/3}Ni_{1/3}Co_{1/3}O₂ and LiMn_{5/12}Ni_{5/12}Co_{1/6}O₂) in addition to LiCoO₂ and the like.

In particular, when the lithium-ion secondary battery is charged to a final voltage that is higher than usual prior to being used, it is preferable that the various active materials shown as the examples above further contain a stabilization element in order to improve the stability of the positive electrode active material in a high-voltage charged state. Examples of such a stabilization element include Mg, Al, Ti, Zr, Mo, and Sn.

The lithium-containing oxide containing Co and/or Mn as mentioned above may be used alone as the positive electrode active material, and the lithium-containing oxide containing Co and/or Mn can also be used together with another positive electrode active material.

Examples of another positive electrode active material that can be used together with the lithium-containing oxide containing Co and/or Mn include: lithium-nickel oxides such as LiNiO₂; lithium-containing composite oxides having a spinel structure such as Li_{4/3}Ti_{5/3}O₄; lithium-containing metal oxides having an olivine structure such as LiFePO₄; and oxides that use the above-mentioned oxides as a basic composition and are substituted with various elements. However, it is preferable that the content of the lithium-containing oxide containing Co and/or Mn with respect to the entire amount of the positive electrode active material contained in the positive electrode mixture layer is 50 mass % or more from the viewpoint that the above-mentioned effects are more favorably secured.

The positive electrode can be obtained by applying a paste or slurry composition containing a positive electrode mixture to a current collector and forming a positive electrode mixture layer having a predetermined thickness and density, the composition being obtained by adding an appropriate solvent (dispersion medium) to a mixture (positive electrode mixture) containing the above-mentioned positive electrode active material, a conductive assistant, and a binder and kneading the resulting mixture sufficiently. It should be noted that the positive electrode is not limited to that obtained using the above-mentioned manufacturing method, and a positive electrode manufactured using another manufacturing method may be used.

The above-mentioned various binders shown as the examples of those for the negative electrode can be used as the binder according to the positive electrode. Also, the above-mentioned various conductive assistants shown as the examples of those for the negative electrode can be used as the conductive assistant according to the positive electrode.

It should be noted that the positive electrode mixture layer according to the above-mentioned positive electrode preferably contains the positive electrode active material in an amount of 79.5 to 99 mass %, the binder in an amount of 0.5 to 20 mass %, and the conductive assistant in an amount of 0.5 to 20 mass %, for example.

Separator

It is preferable that the separator is a porous membrane made of a polyolefin such as polyethylene, polypropylene, or ethylene-propylene copolymer; a polyester such as polyethylene terephthalate or copolymerized polyester; or the like. It should be noted that the separator preferably has a property of closing pores (i.e., shutdown function) at 100 to 140° C. Therefore, it is more preferable that the separator contains a thermoplastic resin having a melting point, that is, a melting temperature measured using a differential scanning calorimeter (DSC) in accordance with the regulations of Japanese Industrial Standards (JIS) K 7121, of 100 to 140° C. as a component. Furthermore, it is preferable that the separator is a single-layer porous membrane containing polyethylene as a main component, or a layered porous membrane including porous membranes as constituents, such as a layered porous membrane having two to five layers obtained by stacking a polyethylene layer and a polypropylene layer. When a mixture or stack of polyethylene and a resin such as polypropylene that has a higher melting point than that of polyethylene is used, it is desirable that the porous membrane contains polyethylene as a constituent resin in an amount of 30 mass % or more, and it is more desirable that the porous membrane contains polyethylene in an amount of 50 mass % or more.

For example, a conventionally known porous membrane that is made of the above-mentioned thermoplastic resins shown as the examples and used in a non-aqueous electrolyte secondary battery and the like, that is, an ion-permeable porous membrane produced using a solvent extraction method, a dry or wet drawing method, or the like, can be used as such a resin porous membrane.

The average pore size of the separator is preferably 0.01 μm or more and more preferably 0.05 μm or more, and preferably 1 μm or less and more preferably 0.5 μm or less.

Regarding the characteristics of the separator, it is desirable that a Gurley value that is measured using a method in conformity with JIS P 8117 and indicated as seconds taken for 100 mL of air to pass through the membrane under a pressure of 0.879 g/mm² is 10 to 500 sec. If the air permeability indicated using a Gurley value is too large, the ion permeability is reduced, whereas if the air permeability is too small, the strength of the separator may be reduced. Furthermore, regarding the strength of the separator, it is desirable that the puncture strength with respect to a needle having a diameter of 1 mm is 50 g or more.

Although the lithium-ion secondary battery of the present invention can be used with the upper limit of charging voltage being set to about 4.2 V in the same manner as in a conventional lithium-ion secondary battery, it can also be used with the upper limit of charging voltage being set to a higher voltage, 4.4 V or higher. Therefore, while the capacity of the lithium-ion secondary battery is increased, the lithium-ion secondary battery can stably exhibit excellent characteristics even when it is repeatedly used for a long period of time. It should be noted that the upper limit of charging voltage of the lithium-ion secondary battery is preferably 4.5 V or less.

The lithium-ion secondary battery of the present invention can be used in the same applications as those of a conventionally known lithium-ion secondary battery.

### EXAMPLES

Hereinafter, the present invention will be described in detail by way of examples. However, the present invention is not limited to the following examples.

### Example 1

Production of Positive Electrode

A twin-screw kneading machine was used to knead 100 parts by mass of LiCoO₂, 20 parts by mass of a NMP solution containing PVDF, which is a binder, at a concentration of 10 mass %, and 1 part by mass of synthetic graphite and 1 part by mass of Ketjen black, which are conductive assistants, the viscosity thereof was adjusted by adding additional NMP, and thus a paste containing a positive electrode mixture was prepared. The paste containing the positive electrode mixture was applied to both surfaces of an aluminum foil (positive electrode current collector) having a thickness of 15 μm, followed by vacuum drying at 120° C. for 12 hours, and thus positive electrode mixture layers were formed on both surfaces of the aluminum foil. Thereafter, press processing was performed to adjust the thicknesses and densities of the positive electrode mixture layers, followed by welding of a lead body made of aluminum to an exposed portion of the aluminum foil, and thus a positive electrode having a belt shape with a length of 600 nm and a width of 54 mm was produced. The thickness of the positive electrode mixture layer on each surface of the obtained positive electrode was 60 μm.

Production of Negative Electrode

A V-type blender was used to mix: 90 parts by mass of a mixture obtained by mixing, at a mass ratio of 50:50, graphite a (synthetic graphite whose surfaces are not coated with amorphous carbon) having an average particle diameter D50% of 22 μm, a 402 of 0.338 nm, a specific surface area of 3.8 m²/g, which was determined using a BET method, and an R value of 0.12 in an argon-ion laser Raman spectrum, and graphite b (graphite obtained by coating the surfaces of mother particles constituted by graphite with amorphous carbon using pitch as a carbon source) having an average particle diameter D50% of 10 μm, a d₀₀₂ of 0.336 nm, a specific surface area of 3.9 m²/g, which was determined using a BET method, and an R value of 0.40 in an argon-ion laser Raman spectrum; and 10 parts by mass of a carbonaceous material A (petroleum coke that had undergone thermal processing at 2000° C.) having an average particle diameter D50% of 20 μm, a d₀₀₂ of 0.350 nm, and a specific surface area of 3.5 m²/g, which was determined using a BET method, for 12 hours, and thus a negative electrode active material was obtained. The mass ratio of the carbonaceous material in the obtained negative electrode active material was 10 mass %. A paste containing an aqueous negative electrode mixture was prepared by mixing 98 parts by mass of this negative electrode active material, 1.0 part by mass of CMC, and 1.0 part by mass of SBR with ion exchanged water.

The ₚaste containing the negative electrode mixture was applied to both surfaces of a copper foil (negative electrode current collector) having a thickness of 8 μm, followed by vacuum drying at 120° C. for 12 hours, and thus negative electrode mixture layers were formed on both surfaces of the copper foil. Thereafter, press processing was performed to adjust the thicknesses and densities of the negative electrode mixture layers, followed by welding of a lead body made of nickel to an exposed portion of the copper foil, and thus a negative electrode having a belt shape with a length of 620 mm and a width of 55 mm was produced. The thickness of the negative electrode mixture layer on each surface of the obtained negative electrode was 70 μm.

Preparation of Non-aqueous Electrolytic Solution

LiPF₆ was dissolved at a concentration of 1.1 mol/L in a mixed solvent containing ethylene carbonate, ethylmethyl carbonate, and diethyl carbonate at a volume ratio of 1:1:1. 4-Fluoro-1,3-dioxolan-2-one, vinylene carbonate, 2-propynyl 2-(diethoxyphosphoryl)acetate, 1,3-dioxane, adiponitrile, and lithium borofluoride (LiBF₄) were added to this solution so as to be contained therein in amounts of 1.5 mass %, 2.0 mass %, 1.5 mass %, 1.0 mass %, 0.5 mass %, and 0.15 mass %, respectively, and thus a non-aqueous electrolytic solution was prepared.

Assembly of Battery

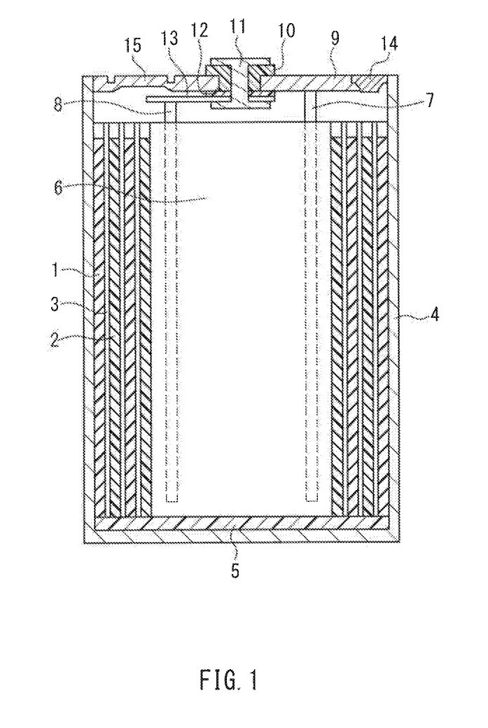

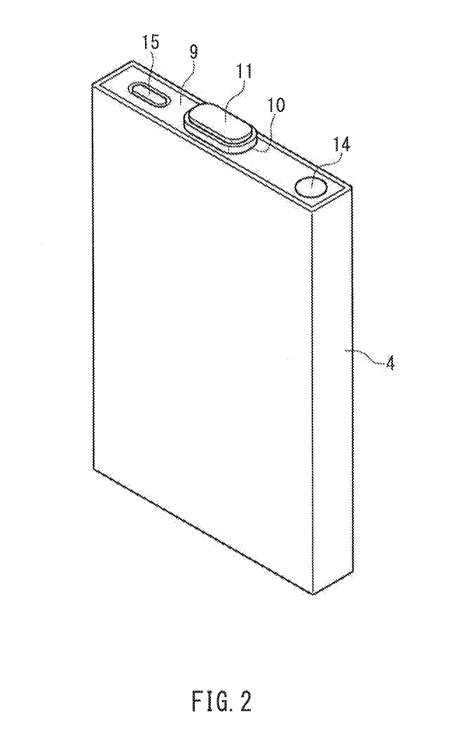

The above-mentioned belt-shaped positive electrode was stacked on the above-mentioned belt-shaped negative electrode with a microporous polyethylene separator (porosity: 41%) having a thickness of 16 μm being sandwiched therebetween. The laminate was wound into a spiral shape and then pressed into a flat shape to produce a wound electrode having a flat wound structure. This wound electrode was fixed with an insulating tape made of polypropylene. Next, the wound electrode was inserted into a rectangular battery case made of an aluminum alloy having a depth of 5.0 mm, a width of 56 mm, and a height of 60 mm as the external dimensions. Lead bodies were welded thereto, and a cover plate made of an aluminum alloy was welded to an open end of the battery case. Thereafter, the above-mentioned non-aqueous electrolytic solution was injected through an inlet formed in the cover plate and left to stand for 1 hour. followed by sealing of the inlet, and thus a lithium-ion secondary battery having a structure shown in FIG. 1 and an appearance shown in FIG. 2 was obtained.

Here, the battery shown in FIGS. 1 and 2 will be described. FIG. 1 is a partial cross-sectional view. As shown in FIG. 1, a positive electrode 1 and a negative electrode 2 are wound into a spiral shape with a separator 3 being sandwiched therebetween and pressed into a flat shape, and thus a flat wound electrode 6 is formed. The wound electrode 6 is accommodated in a rectangular (rectangular tube shaped) battery case 4 together with a non-aqueous electrolytic solution. However, metal foils serving as a current collector that are used to produce the positive electrode 1 and the negative electrode 2, the layers in the separator, the non-aqueous electrolytic solution, and the like are not shown in FIG. 1 in order to prevent the diagram from being complicated.

The battery case 4 is made of an aluminum alloy and constitutes the exterior body of the battery. This battery case 4 also serves as a positive electrode terminal. An insulator 5 made of a PE sheet is arranged on the bottom portion of the battery case 4. A positive electrode lead body 7 and a negative electrode lead body 8 that are respectively connected to one end of the positive electrode 1 and one end of the negative electrode 2 are drawn out from the flat wound electrode 6 including the positive electrode 1, the negative electrode 2, and the separator 3. A terminal 11 made of stainless steel is attached to a sealing cover plate 9 made of an aluminum alloy for sealing the opening portion of the battery case 4, via an insulating packing 10 made of polypropylene, and a lead plate 13 made of stainless steel is attached to this terminal 11 via an insulator 12.

This cover plate 9 is inserted into the opening portion of the battery case 4. The opening portion of the battery case 4 is sealed by welding the cover plate 9 and the battery case 4 together to form a joined portion, and thus the inside of the battery is sealed. In the battery shown in FIG. 1, a non-aqueous electrolytic solution inlet 14 is formed in the cover plate 9. A sealing member is inserted into this non-aqueous electrolytic solution inlet 14, and welded and sealed through laser welding, for example, and thus the sealing performance of the battery is secured. Furthermore, a cleavage vent 15 serving as a mechanism for discharging an internal gas to the outside when the temperature of the battery rises is provided in the cover plate 9.

In the battery of Example 1, the battery case 4 and the cover plate 9 function as a positive electrode terminal by directly welding the positive electrode lead body 7 to the cover plate 9, and the terminal 11 functions as the negative electrode terminal by welding the negative electrode lead body 8 to the lead plate 13 to electrically connect the negative electrode lead body 8 and the terminal 11 via the lead plate 13. However, positive and negative may be inverted depending on the material of the battery case 4.

FIG. 2 is a perspective view, schematically showing the appearance of the battery shown in FIG. 1 above. FIG. 2 is shown for the purpose of showing that the battery is a rectangular battery. The battery is schematically shown in FIG. 2, and only specific constituent members of the battery are shown. Moreover, a cross section of a portion on the internal peripheral side of the electrode is not shown in FIG. 1.

### Examples 2 to 17

Lithium-ion secondary batteries were produced in the same manner as in Example 1, except that the contents of LiBF₄ and adiponitrile were changed as shown in Table 1.

### Examples 18 to 21

Lithium-ion secondary batteries were produced in the same manner as in Example 1, except that the content of the carbonaceous material A in the negative electrode active material was changed as shown in Table 1.

### Example 22

A V-type blender was used to mix: 90 parts by mass of graphite a having an average particle diameter D50% of 22 μm, a d₀₀₂ of 0.338 nm, a specific surface area of 3.8 m²/g, which was determined using a BET method, and an R value of 0.12 in an argon-ion laser Raman spectrum; and 10 parts by mass of a carbonaceous material B (petroleum coke that had undergone thermal processing at 1600° C.) having an average particle diameter D50% of 20 μm, a d₀₀₂ of 0.360 nm, and a specific surface area of 3.5 m²/g, which was determined using a BET method, for 12 hours, and thus a negative electrode active material was obtained. A lithium-ion secondary battery was produced in the same manner as in Example 1, except that this negative electrode active material was used.

### Example 23

A lithium-ion secondary battery was produced in the same manner as in Example 22, except that a carbonaceous material C (phenol resin that had undergone thermal processing at 1000° C.) having an average particle diameter D50% of 20 μm, a d₀₀₂ of 0.380 nm, and a specific surface area of 3.5 m²/g, which was determined using a BET method, was used as the carbonaceous material.

### Example 24

A lithium-ion secondary battery was produced in the same manner as in Example 1, except that succinonitrile was used instead of adiponitrile contained in the non-aqueous electrolytic solution.

### Example 25

A lithium-ion secondary battery was produced in the same manner as in Example 1, except that glutaronitrile was used instead of adiponitrile contained in the non-aqueous electrolytic solution.

### Example 26

A lithium-ion secondary battery was produced in the same manner as in Example 1, except that laurylonitrile was used instead of adiponitrile contained in the non-aqueous electrolytic solution.

### Example 27

A lithium-ion secondary battery was produced in the same manner as in Example 1, except that a non-aqueous electrolytic solution containing no 2-propynyl 2-(diethoxyphosphoryflacetate was used.

### Example 28

A lithium-ion secondary battery was produced in the same manner as in Example 1, except that a non-aqueous electrolytic solution containing no 1,3-dioxane was used.

### Example 29

A lithium-ion secondary battery was produced in the same manner as in Example 1, except that a non-aqueous electrolytic solution containing no 4-fluoro-1,3-dioxolan-2-one was used.

### Comparative Example 1

A lithium-ion secondary battery was produced in the same manner as in Example 1, except that the negative electrode active material contained no carbonaceous material, and the non-aqueous electrolytic solution contained no LiBF₄ and no adiponitrile.

### Comparative Example 2

A lithium-ion secondary battery was produced in the same manner as in Example 1, except that the negative electrode active material contained no carbonaceous material.

### Comparative Example 3

A lithium-ion secondary battery was produced in the same manner as in Example 1, except that the non-aqueous electrolytic solution contained no LiBF₄.

### Comparative Example 4

A lithium-ion secondary battery was produced in the same manner as in Example 1, except that the non-aqueous electrolytic solution contained no adiponitrile.

### Comparative Examples 5 and 6

Lithium-ion secondary batteries were produced in the same manner as in Example 1, except that the content of the carbonaceous material A in the negative electrode active material was changed as shown in Table 1.

### Comparative Examples 7 to 9

Lithium-ion secondary batteries were produced in the same manner as in Example 1, except that the contents of LiBF₄ and adiponitrile were changed as shown in Table 1.

TABLE 1

| | Carbonaceous | LiBF₄ | Nitrile compound |
|---|---|---|---|
| | material (mass %) | (mass %) | (mass %) |
| Ex. 1 | 10 | 0.15 | 0.5 |
| Ex. 2 | 10 | 0.05 | 0.5 |
| Ex. 3 | 10 | 0.35 | 0.5 |
| Ex. 4 | 10 | 0.50 | 0.5 |
| Ex. 5 | 10 | 1.00 | 0.5 |
| Ex. 6 | 10 | 1.50 | 0.5 |
| Ex. 7 | 10 | 2.00 | 0.5 |
| Ex. 8 | 10 | 2.50 | 0.5 |
| Ex. 9 | 10 | 0.15 | 0.05 |
| Ex. 10 | 10 | 0.15 | 0.1 |
| Ex. 11 | 10 | 0.15 | 0.3 |
| Ex. 12 | 10 | 0.15 | 0.7 |
| Ex. 13 | 10 | 0.15 | 1.0 |
| Ex. 14 | 10 | 0.15 | 2.0 |
| Ex. 15 | 10 | 0.15 | 3.0 |
| Ex. 16 | 10 | 0.15 | 4.0 |
| Ex. 17 | 10 | 0.15 | 5.0 |
| Ex. 18 | 5 | 0.15 | 0.5 |
| Ex. 19 | 7 | 0.15 | 0.5 |
| Ex. 20 | 12 | 0.15 | 0.5 |
| Ex. 21 | 15 | 0.15 | 0.5 |
| Ex. 22 | 10 | 0.15 | 0.5 |
| Ex. 23 | 10 | 0.15 | 0.5 |
| Ex. 24 | 10 | 0.15 | 0.5 |
| Ex. 25 | 10 | 0.15 | 0.5 |
| Ex. 26 | 10 | 0.15 | 0.5 |
| Ex. 27 | 10 | 0.15 | 0.5 |
| Ex. 28 | 10 | 0.15 | 0.5 |
| Ex. 29 | 10 | 0.15 | 0.5 |
| Comp. Ex. 1 | 0 | 0 | 0 |
| Comp. Ex. 2 | 0 | 0.15 | 0.5 |
| Comp. Ex. 3 | 10 | 0 | 0.5 |
| Comp. Ex. 4 | 10 | 0.15 | 0 |
| Comp. Ex. 5 | 20 | 0.15 | 0.5 |
| Comp. Ex. 6 | 1 | 0.15 | 0.5 |
| Comp. Ex. 7 | 10 | 3 | 0.5 |
| Comp. Ex. 8 | 10 | 0.15 | 5.5 |
| Comp. Ex. 9 | 10 | 0.15 | 0.01 |

The lithium-ion secondary batteries of the examples and comparative examples were evaluated for the following battery characteristics.

45° C. Charge-Discharge Cycle Characteristics

Each of the lithium-ion secondary batteries of the examples and comparative examples was left to stand in a constant temperature chamber in which the temperature was set to 45° C. for 5 hours, and the initial discharge capacity was determined by charging each battery to 4.4 V with a constant current at a current value of 0.5 C, followed by constant-voltage charging at 4.4 V (total charging time of constant-current charging and constant-voltage charging was 2.5 hours), and then discharging the battery to 2.75 V with a constant current at a current value of 0.2 C. Next, a series of operations including charging each battery to 4.4 V with a constant current at a current value of 1 C, followed by constant-voltage charging to a current value of 0.1 C at 4.4 V, and then discharging the battery to 3.0 Vat a current value of 1 C was taken as one cycle, and a plurality of cycles were repeated at 45° C. Then, constant-current and constant-voltage charging and constant-current discharging were performed on each battery in the same conditions as those of the above-mentioned measurement of initial discharge capacity, and thus discharge capacity was determined. A 45° C. cycle capacity maintenance rate was calculated by expressing, as a percentage, a value obtained by dividing this discharge capacity by the initial discharge capacity, and the number of cycles with which the capacity maintenance rate was reduced to 40% was measured. The number of cycles is shown as “45° C. cycle number” in Table 2.

High-Temperature Storage Characteristics in Charged State

Each of the lithium-ion secondary batteries of the examples and comparative examples was charged with a constant current at a current value of 1.0 C in a room temperature environment (23° C.), and then charged with a constant voltage at a voltage of 4.4 V. It should be noted that the total charging time of constant-current charging and constant-voltage charging was set to 2.5 hours. Thereafter, the battery was discharged to 2.75 V at a current value of 0.2 C, and capacity prior to storage (initial capacity) was determined. Next, after stored in an environment at 85° C. for 24 hours, the battery was discharged to 2.75 V at a current value of 0.2 C. Then, the battery was charged to 4.4 V with a constant current at a current value of 1.0 C, and subsequently charged with a constant voltage at a voltage of 4.4 V. It should be noted that the total charging time of constant-current charging and constant-voltage charging was set to 2.5 hours. Thereafter, the battery was discharged to 2.75 V at a current value of 0.2 C, and capacity after storage (recovery capacity) was determined. A capacity recovery rate (%) after high-temperature storage was determined in accordance with the following equation. It can be said that the higher this capacity recovery rate is, the better the high-temperature storage characteristics of the battery is. The capacity recovery rate is shown as “85° C. capacity recover rate” in Table 2.

Capacity recovery rate after high-temperature storage=(recovery capacity after storage/initial capacity prior to storage)×100

Overcharge Characteristics

Five lithium-ion secondary batteries were prepared for each of the examples and comparative examples and charged at a current value of 1 A (upper limit voltage: 5.2 V), and a change in temperature of the surface of each battery during charging was measured. A battery in which the temperature of the surface exceeded 100° C. was considered as a battery in which a significant rise in temperature was observed, and the number thereof was checked. The number is shown as “number of batteries with rising temperature” in Table 2.

TABLE 2

| | 45° C. | | Number of batteries |
|---|---|---|---|
| | cycle | 85° C. capacity recover | with rising |
| | number | rate (%) | temperature |
| Ex. 1 | 900 | 85 | 0 |
| Ex. 2 | 870 | 84 | 0 |
| Ex. 3 | 890 | 84 | 0 |
| Ex. 4 | 880 | 84 | 0 |
| Ex. 5 | 880 | 84 | 0 |
| Ex. 6 | 880 | 84 | 0 |
| Ex. 7 | 880 | 84 | 0 |
| Ex. 8 | 875 | 84 | 0 |
| Ex. 9 | 870 | 83 | 0 |
| Ex. 10 | 880 | 83 | 0 |
| Ex. 11 | 890 | 84 | 0 |
| Ex. 12 | 890 | 84 | 0 |
| Ex. 13 | 880 | 83 | 0 |
| Ex. 14 | 880 | 83 | 0 |
| Ex. 15 | 880 | 83 | 0 |
| Ex. 16 | 880 | 83 | 0 |
| Ex. 17 | 880 | 83 | 0 |
| Ex. 18 | 870 | 83 | 0 |
| Ex. 19 | 870 | 83 | 0 |
| Ex. 20 | 870 | 83 | 0 |
| Ex. 21 | 870 | 83 | 0 |
| Ex. 22 | 890 | 85 | 0 |
| Ex. 23 | 890 | 85 | 0 |
| Ex. 24 | 890 | 84 | 0 |
| Ex. 25 | 890 | 84 | 0 |
| Ex. 26 | 890 | 84 | 0 |
| Ex. 27 | 750 | 82 | 0 |
| Ex. 28 | 750 | 81 | 0 |
| Ex. 29 | 750 | 81 | 0 |
| Comp. Ex. 1 | 450 | 79 | 5 |
| Comp. Ex. 2 | 450 | 82 | 3 |
| Comp. Ex. 3 | 450 | 79 | 0 |
| Comp. Ex. 4 | 460 | 79 | 3 |
| Comp. Ex. 5 | 450 | 82 | 0 |
| Comp. Ex. 6 | 460 | 82 | 2 |
| Comp. Ex. 7 | 450 | 82 | 0 |
| Comp. Ex. 8 | 450 | 79 | 0 |
| Comp. Ex. 9 | 460 | 82 | 2 |

It was found from Table 2 that all the results regarding the 45° C. charge-discharge cycle characteristics, the high-temperature storage characteristics, and the overcharge characteristics from Examples 1 to 26 of the present invention were acceptable. Regarding the battery of Example 27 using the non-aqueous electrolytic solution containing no 2-propynyl 2-(diethoxyphosphoryl)acetate, the battery of Example 28 using the non-aqueous electrolytic solution containing no 1,3-dioxane, and the battery of Example 29 using the non-aqueous electrolytic solution containing no 4-fluoro-1,3-dioxolan-2-one, which are the batteries of the present invention, the 45° C. charge-discharge cycle characteristics and the high-temperature storage characteristics were slightly deteriorated, but the level of deterioration was such that no practical problems arose, and the overcharge characteristics were of a high level.

On the other hand, the 45° C. charge-discharge cycle characteristics were deteriorated in all the batteries of Comparative Examples 1 to 9. Furthermore, the high-temperature storage characteristics and the overcharge characteristics were deteriorated in the batteries of Comparative Examples 1 and 4, the overcharge characteristics were deteriorated in the batteries of Comparative Examples 2, 6, and 9, and the high-temperature storage characteristics were deteriorated in the batteries of Comparative Examples 3 and 8.

The present invention may be embodied in other forms without departing from the spirit or essential characteristics thereof. The embodiment disclosed in this application is to be considered in all respects as illustrative and not limiting. The scope of the present invention is indicated by the appended claims rather than by the foregoing description, and all changes which come within the meaning and range of equivalency of the claims are intended to be embraced therein.

### LIST OF REFERENCE NUMERALS

1 Positive electrode

2 Negative electrode

3 Separator

4 Battery case

5 Insulator

6 Wound electrode

7 Positive electrode lead body

8 Negative electrode lead body

9 Cover plate

10 Insulating packing

11 Terminal

12 Insulator

13 Lead plate

14 Non-aqueous electrolytic solution inlet

15 Cleavage vent

1-5. (canceled)

6. A lithium-ion secondary battery comprising:
a positive electrode;
a negative electrode;
a non-aqueous electrolytic solution; and
a separator,
wherein the positive electrode comprises, as a positive electrode active material, a lithium-containing oxide that contains at least one element selected from Co and Mn,
the negative electrode comprises, as a negative electrode active material, a mixture of graphite having a d₀₀₂ in X-ray diffraction of 0.338 nm or less and a carbonaceous material having a d₀₀₂ in X-ray diffraction of 0.340 to 0.380 nm,
the negative electrode active material contains the carbonaceous material in an amount of 5 to 15 mass %,
the non-aqueous electrolytic solution contains LiBF₄, a nitrile compound having one or more cyano groups, and LiPF₆, and
the non-aqueous electrolytic solution contains the LiBF₄ in an amount of 0.05 to 2.5 mass % and the nitrile compound in an amount of 0.05 to 5.0 mass %.

7. The lithium-ion secondary battery according to claim 6, wherein the nitrile compound is represented by General Formula (1):
NC—(CH₂)ₙ—CN (1)
where n is an integer between 2 to 4.

8. The lithium-ion secondary battery according to claim 6, wherein the non-aqueous electrolytic solution further contains a phosphonoacetate compound represented by General Formula (2): 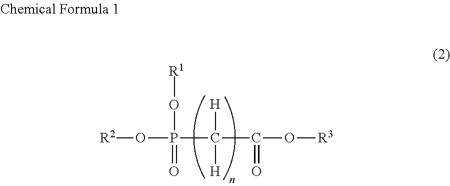
where R¹, R², and R³ independently represent an alkyl group, an alkenyl group, or an alkynyl group that has 1 to 12 carbon atoms and is optionally substituted with a halogen, and n represents an integer between 0 to 6.

9. The lithium-ion secondary battery according to claim 6, wherein the non-aqueous electrolytic solution further contains 1,3-dioxane.

10. The lithium-ion secondary battery according to claim 6, wherein the non-aqueous electrolytic solution further contains vinylene carbonate and 4-fluoro-1,3-dioxolan-2-one.
